(19) United States
(12) Patent Application Publication
(10) Pub. No.: US 2023/0212478 A1
(43) Pub. Date: Jul. 6, 2023

(54) COLD PRESSING METHOD AND DEVICE IMPLEMENTING SAID METHOD

(71) Applicant: Avril, Paris (FR)

(72) Inventors: Eric MONVOISIN, Auppegard (FR); Laurent DUNACH, Saint Ouen du Tilleul (FR); Laurine BOGAERT, Le Meux (FR)

(21) Appl. No.: 17/927,533

(22) PCT Filed: May 27, 2021
(86) PCT No.: PCT/EP2021/064173

§ 371 Date: Nov. 23, 2022

(30) Foreign Application Priority Data
May 27, 2020 (FR) 2005582

(51) Int. Cl. C11B 1/04; B30B 9/14; C11B 1/06

(52) U.S. Cl. CPC C11B 1/04; B30B 9/14; C11B 1/06

(57) ABSTRACT

The invention relates to a method for extracting oil from seeds or fruits of oilseed plants, comprising a pressing step and a step of separating the oily and solid fractions, wherein at least a part of the seeds or fruit is moistened prior to the pressing step. The invention also relates to a device for implementing said method.

The invention relates to a cold pressing method and a device for implementing said method.

Traditionally, to realize the cold pressing of oilseeds, producers or manufacturers use specific presses. These presses must make it possible to extract a maximum amount of oil from the seed while limiting the heating of the material in order to guarantee the properties of both the oil and the cake.

The control of the temperature of the press cake seems to be an emerging issue. In the past, the attention of crushers was mainly focused on improving oil yields through thermal, mechanical and chemical treatments, with the aim of extracting almost all of the available oil.

In this context, the available studies generally present the temperature either as a secondary result of the applied operating conditions, or as a parameter which, if elevated, can improve the pressing.

Moreover, the temperature of the cake is very rarely mentioned, in favor of the temperature of the press cage, which is easier to measure and control.

However, in view of the emergence of the purification of bio-available proteins contained in the pressing residues, and their use in particular in human and animal nutrition, it is becoming increasingly relevant to control the quality of these proteins, and thus to obtain cakes of which the organoleptic qualities are not or are only slightly modified, and in particular which have not coagulated or denatured under the effect of heat during pressing.

Therefore, the problem of controlling the temperature of the oil and cakes is becoming a problem of industrial importance.

To address this problem of limiting the temperature of oil and cake resulting from the pressing, cooling equipment presses have been developed progressively, for example by circulating water in the shaft, in the rings of the arrangement, in the cage of the press or at the throttling area prior to the exit of the cake. Other techniques consist of cooling on the press cage, for example by using dry ice on the external surface of the cage, by spraying cold clarified oil, etc.

An example of this is application WO200220705, which describes one such cooling system that cools the extruder housing and/or the press screw.

However, such a device is not advantageous because it requires the adaptation of presses currently on the market and has an energy cost of operation.

Also, despite what the prior art proposes, there is still a need to control the temperature during pressing, so that the oil and especially the cake do not undergo excessive temperature rises.

One of the objects of the invention is therefore to provide a simple method to alleviate the above problem.

Another object of the invention is also to provide a pressing device for implementing the above-mentioned method.

Also, the invention proposes a method for extracting oil from seeds or fruits of oilseed plants, especially seeds or fruits of oilseed protein plants, the method comprising:
one or more steps of cold pressing of the seeds or fruits by means of one or more presses, said seeds or fruits being conveyed to the press by a conveyor,
a step of separation of the oily fraction and the solid fraction (or cake),

said method being characterized in that at least a part of the seeds or fruits is moistened with an aqueous solution before pressing said seeds or fruits in order to decrease the temperature of the oil and cakes resulting from the pressing.

The invention is based on the surprising observation made by the inventors that the addition of an aqueous solution to a flow of seeds or fruits or cakes introduced into a press reduces their adhesion and, thus, their overall coefficient of friction during pressing (tribological behavior). In this way, the heat production resulting from the friction between the compressed material and the internal surfaces of the press (screw and cage) is reduced and the temperature of the cake and oil produced is lower than in the absence of aqueous solution.

The method of the invention is a method for pressing seeds or fruits or cakes of oilseed plants, i.e. seeds or plants comprising a significant amount of fatty acids, especially in the form of triglycerides.

In the context of the invention it is possible that the seeds or fruits are pressed a first time, so that oil is separated from the remaining de-oiled product, which is also called the cake. The cake may also be pressed in turn and subjected to a pressing similar to that of the seeds or fruits of oilseed plants, including contact with an aqueous solution in order to be moistened.

Also, in the invention, when reference is made to “seeds or fruits of oilseed plants” and several pressing steps are envisaged, the seeds or fruits should be interpreted as also including the cakes.

In the case of two successive pressings, the invention will relate to a method for extracting oil from seeds or fruits of oilseed plants, in particular seeds or fruits of oilseed protein plants, the method comprising:
a first step of cold pressing of the seeds or fruits by means of a first press, said seeds or fruits being conveyed to the press by a first conveyor,
a step of separation of the oily fraction and the solid fraction or cake,
a second step of pressing of the solid fraction obtained in the previous step by means of a second press, said solid fraction being conveyed to the second press by a second conveyor

said method being characterized in that at least part of the seeds or fruits introduced into the first press and at least part of the solid fraction introduced into the second press is moistened with an aqueous solution
prior to the pressing of said seeds or fruits in the first pressing step or
prior to the pressing of said solid fraction in the second pressing step, in order to decrease the temperature of the oil and cakes resulting from each of the first and second pressings.

The oilseed plants of which the seeds or fruits are used in the method as described above, can be, without limitation, Brassicaceae, such as rapeseed (e.g., winter or spring rapeseed), canola, mustard, but also sunflower, flax, camelina, soybean, peanut, palm, olive, nut plants (almond, walnut, hazelnut, etc.), argan, or coconut palm. It is advantageous to use seeds or fruits of oilseed protein plants, that is to say plants rich in fatty acids and vegetable proteins. These oilseed protein plants are useful for the production of oil as such, but also for the use of the proteins contained in the cakes obtained after pressing, in particular for the production of human and animal food. Advantageous oilseed protein plants according to the invention may be, but are not limited to, rapeseed (e.g., winter or spring rapeseed), canola, mustard, sunflower, flax, camelina, soybean, or peanut, preferably rapeseed, canola, soybean and sunflower, and more preferably rapeseed or canola.

These different plants must reach maturity for the oil content to be optimal. The person skilled in the art is able to determine the appropriate maturity for a pressing giving a good oil production yield.

According to an advantageous embodiment of the invention, the seeds or fruits are not hulled and/or are not pretreated prior to the pressing step. The term “pretreatment” means the flaking (flattening) of the seeds or fruits. Also, advantageously in the invention, the expression “whole seeds or fruits” means seeds or fruits that are neither hulled nor pretreated.

Advantageously, the seeds or fruits are cleaned. Industrially, the cleaning step is carried out by mechanical separation of the various constituents present in the batch of seeds or fruits, so as to eliminate the foreign bodies that may be contained in the batch.

The aforementioned method is an oil extraction method, as it yields oil and a by-product rich in protein and plant fiber called cake. Insofar as two products are obtained after this method, oil and cake, the method of the invention also corresponds to a method for separating the oil from the other components of the fruits or seeds of oilseed plants. The method may also be referred to as a method for the production of de-oiled cake from seeds or fruits of oilseed plants. Thus, when reference is made in the invention to the oil extraction method, reference will also be made to the separation or cake extraction methods as mentioned above.

In the foregoing and the following, “cake” is defined as the material substantially de-oiled from the seeds or fruits from which it is derived and which comes out of the press after pressing of the seeds or fruits of oilseed plants. The cake is a material rich in fiber and protein, and is produced in the form of powder, flakes (kind of platelet resembling scales), or pellets.

The extraction method as described above is a so-called “cold extraction” method, i.e. the seeds or fruits of oilseed plants are neither heated nor undergo chemical treatment or refining.

The aforementioned pressing method includes two main steps:
a pressing step as such, which is commonly referred to as trituration and corresponds to friction grinding, combining a frictional movement and a strong pressure, and
a step of collection of the oil and the residue of pressing, the cake.

According to the method described above, the pressing or trituration step can be repeated one or more times. This repetition can in particular be carried out within the same press, by a particular arrangement of the elements constituting the press.

The most commonly used presses are those with a worm screw surrounded by a (often metal) cage. When the seeds or fruits are introduced into the press, they progress through the press with the help of the worm screw which is configured so that the space between the screw shaft and the walls of the cage surrounding the screw decreases as progress is made along the screw. The seeds and fruits are then increasingly crushed with each other between the screw and the wall, generating friction and increasing the pressure. This friction and increased pressure allow the release of the oil contained in the seeds. These different presses are well known to the person skilled in the art, with examples including the Reinartz AP15 press, the Olexa presses, the Rosedowns presses, and many others.

The second step is a step of collection of the oily or fatty fraction from the trituration, and of the solid fraction. Advantageously, the presses used have a perforated cage allowing, as the trituration or pressing proceeds, the oil that has just been separated from the solid part (protein, fibers) of the seed or fruit to flow out. Therefore, the oil is collected continuously throughout the press as the seeds and fruits move through the press via the worm screw. At the end of the press, the solid residue or cake is recovered continuously, in solid form, or in a pasty or liquid form, depending on the degree of moisture in the residue.

Thus, at the end of the pressing or trituration, the oil will have been collected progressively, while the cake is collected at the end of the press.

The oil thus obtained could then be decanted and possibly treated if necessary. The cake could also be treated later, in particular to extract proteins intended for human or animal consumption.

The presses used in the context of the trituration of seeds and fruits of oilseed plants are fed with products to be pressed, or “continuously fed” by a conveyor, that is to say a means making it possible to introduce said seeds or fruits at the worm screw of the press. These conveyors can take different forms and can be belts, funnels, worm screws, or any type of means allowing the introduction of the products to be pressed in the press.

The method according to the invention is such that before the seeds and fruits are introduced into the press, they are brought into contact with an aqueous solution so that the seeds and fruits are moistened; this moistening will on the one hand reduce the friction between the seeds, and between the seeds or fruits and the walls of the press parts (cage, screw, etc.) during the trituration, and on the other hand will reduce the adhesion between the fruit and seeds, and will thus, without preventing the extraction of oil, reduce the temperature within the press and thus reduce the temperature of oil and cake that result from this pressing or trituration. The aqueous solution acts as a lubricant between the seeds or fruits during the trituration.

In the invention, it is specified that the seeds or fruits of oilseed plants are at least partially moistened by the aqueous solution. This means that not all seeds or fruits are brought into contact with said aqueous solution, so that some fruits or seeds will be in contact with the aqueous solution, and others will not. What is important in the method is that aqueous solution is present to exert the above-mentioned effect, even if not all the fruits or seeds or cakes are in contact with said solution.

The additional moisture incorporated in the seeds or fruits of oilseed plants, or cakes in case of successive pressings, is understood in the invention as a moisture that does not take into account the intrinsic water content of the seeds or fruits, or where appropriate cakes. This additional moisture by the addition of the aqueous solution will form an interstitial aqueous layer outside the seeds or fruits and between them, but also between the fruits and seeds and the internal parts of the press (walls, screws, etc.), or where appropriate cakes. This interstitial layer, or this layer of free aqueous solution, aims to reduce the overall coefficient of friction during pressing, and thus limit temperature rises.

The aqueous solution according to the invention is advantageously water directly obtained from drinking water supply circuits. It can also be steam condensate, or purified (e.g. filtered) or desalinated, demineralized or distilled water, according to techniques well known to the person skilled in the art.

The aqueous solution may consist of water only, or of water and certain additives dissolved therein. Advantageous additives are, for example, food-compatible disinfectants, such as weak acids, bicarbonate salts or alcohols.

This aqueous solution which is put in contact with the seeds or fruits of the oilseed plants is at a temperature which can vary from 4° C. to 90° C., but is preferably used at a temperature known as “ambient,” i.e. at a temperature varying from 16° C. to 35° C. This means that the aqueous solution is at a temperature which can be 16° C., 17° C., 18° C., 19° C., 20° C., 21° C. 22° C., 23° C., 24° C., 25° C., 26° C., 27° C., 28° C., 29° C., 30° C., 31° C., 32° C., 33° C., 34° C. or 35° C.

In an advantageous embodiment, the invention relates to the aforementioned method, wherein the aqueous solution is added at a determined flow rate, such that the ratio between said determined flow rate and the flow rate of at least partially moistened seeds or fruits introduced into the press varies from 0.2 to 10%, in particular from 0.2 to 5%, preferably from 0.5 to 2%, in particular about 1%.

It is advantageous that the aqueous solution is added to the seeds or fruits before they are introduced into the press at a specific flow rate (Dd). This flow rate is calculated according to the flow rate of seeds or fruits introduced (Di) into the press so that the ratio Dd/Di varies from 0.2% to 10%.

The flow rate Dd is generally expressed in L·h⁻¹ (that is to say about 1 kg·h⁻¹ for water) while the flow rate of seeds or fruits Di is expressed in tons·h⁻¹ (that is to say 1000 kg·h⁻¹). For example, for a ratio of 1%, in the context of a press of which the feed rate is 0.8 tons·h⁻¹ (800 kg·h⁻¹), the flow rate would be 8 L·h⁻¹. Based on this example, the person skilled in the art will easily know how to choose the determined flow rate of the aqueous solution to be added.

It is specified in the invention that the ratio Dd/Di varies from 0.2 to 10%, which means that this ratio can assume the following values: 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.1%, 2.2%, 2.3%, 2.4%, 2.5%, 2.6%, 2.7%, 2.8%, 2.9%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9%, 7%, 7.1%, 7.2%, 7.3%, 7.4%, 7.5%, 7.6%, 7.7%, 7.8%, 7.9%, 8%, 8.1%, 8.2%, 8.3%, 8.4%, 8.5%, 8.6%, 8.7%, 8.8%, 8.9%, 9%, 9.1%, 9.2%, 9.3%, 9.4%, 9.5%, 9.6%, 9.7%, 9.8%, 9.9% and 10%.

Advantageously, the aqueous solution is added, in particular at the above-mentioned determined flow rate, by sprinkling, in particular drop by drop, or by spraying or projection, or by nebulization, or by immersion.

As mentioned above, the contact may not be uniform, that is to say that not all the fruits or seeds are in contact with the aqueous solution, which is compatible with an addition drop by drop, or by spraying or projection, or by nebulization. Reference will then be made to a heterogeneous moistening, i.e. microscopically some seeds will be very wet, and others only a little wet or not wet at all.

When adding the aqueous solution to the seeds or fruits, or if necessary the cakes, it is advantageous that the moisture content of the seeds or fruits after this operation is 4 to 15% when entering the press, that is to say a moisture of 4, 5, 6, 7, 8, 9, 10, 11, 12, 13, 14 or 15%, the percentages being expressed in mass of water in relation to the total mass of the immersed or soaked seeds or fruits. This moisture is measured by conventional techniques, and in particular by the method described in the international standard ISO 665 in its March 2020 version, which describes a method for determining the water and volatile matter content of oilseeds.

Advantageously, the invention relates to the aforementioned method, wherein said seeds or fruits are moistened by soaking in said aqueous solution for 0 to 30 minutes, so that said moistened seeds or fruits have a moisture content of 4% to 15%.

Advantageously, when the aqueous solution is brought into contact with the seeds or fruits, or rapeseed, by spraying, the contact can be made by spraying or nebulizing said aqueous solution over a short period of time, in particular less than 5 minutes, for example from 1 second to less than 5 minutes, in particular from 5 seconds to 3 minutes.

In an even more advantageous aspect, it is possible to control the spraying of the seeds or fruits, or of the rapeseed, by means of a system for controlling the flow rate of the aqueous solution, for example by means of a valve, possibly coupled to a regulator associated with a preferred control means, a regulating valve associated with a flowmeter. Even more advantageously, the system for controlling the flow rate of the aqueous solution can itself be mechanically controlled by a system for measuring the temperature at the press outlet. Also, at the end of the pressing, a cake exits and its temperature is measured as mentioned below. If this temperature is too high, beyond a predefined threshold, the mechanical control system can regulate the spraying of seeds or fruits, or rapeseed, by acting for example on the valve, and/or possibly on the regulator if the system is provided.

In another embodiment, the aqueous solution is brought into contact with the seeds or fruits of oilseed plants by soaking, i.e., the seeds or fruits are soaked or immersed in said aqueous solution.

Means for soaking the seeds or fruits, or if necessary the cakes, can be any means known to the person skilled in the art making it possible to contain the aqueous solution to a sufficient volume so that the seeds or fruits, or if necessary the cakes, can be immersed therein. Examples of means can be, without being limiting, basins, tubs, vats etc.

Although the presence of water between the seeds or fruits to be pressed can reduce the temperature inside the press during pressing or trituration, it is not advantageous that the seeds or fruits, or if necessary the cakes, take on too much moisture. Indeed, if the fruits or seeds remain immersed for too long in the aqueous solution, they may degrade (waterlogging, rotting etc.), and therefore the immersion time must be controlled.

Therefore, it is advantageous to soak or immerse fruits or seeds for 0 to 30 minutes at most. The expression “0 to 30 min” means soaking or immersion times of 0, 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 min. The expression “0 min” shall be understood in the invention to mean that the soaking is less than one minute, and corresponds for example to the immersion in the aqueous solution followed immediately by the removal of the seeds or fruits from the aqueous solution.

During soaking or immersion, it is advantageous that the moisture content of seeds or fruits after this operation is 4 to 15% when entering the press, i.e., a moisture of 4, 5, 6, 7, 8, 9, 10, 11, 12, 13, 14 or 15%, the percentages being expressed in mass of water in relation to the total mass of immersed or soaked seeds or fruits. This moisture is measured by conventional techniques, and in particular by the method described in the international standard ISO 665 in its March 2020 version, which specifies a method for determining the water and volatile matter content of oilseeds.

An advantageous way to control this moisture after soaking or immersion is to subject the seeds or fruits to a draining step. During this step, the excess of aqueous solution will be eliminated, and only a quantity of water will remain to solve the problem posed by the invention during pressing, in particular in the form of a light liquid film between all or part of the seeds or fruits.

Advantageously, the invention relates to the aforementioned method, wherein the aqueous solution is brought into contact with said fruits or seeds between 0 min, i.e. upon entry into the press of said seeds or fruits, and the time, expressed in minutes, required to convey the seeds and fruits through the conveyor.

As already mentioned above, it is preferable that the seeds or fruits do not remain in contact with the aqueous solution for too long in order to prevent the seeds or fruits from being damaged before they enter the press. It is therefore advantageous to carry out the soaking or contact of the aqueous solution with the seeds or fruits to be pressed in a time interval varying from 0 min to the time necessary for the seeds or fruits to pass along the conveyor, before their entry into the press.

A time of 0 min corresponds to a placement in contact at the press inlet. This means that the seeds or fruits are brought into contact with the aqueous solution and less than one minute elapses before the seeds or fruits enter the press.

If, on the other hand, the aqueous solution is brought into contact at the beginning of the conveyor, the contact time will be that required to convey the moistened seeds or fruit to the press inlet.

Advantageously, the invention relates to the above-mentioned method, wherein the temperature within the press is lower than 100° C., preferably lower than 85° C., in particular lower than 80° C., more particularly lower than 75° C., even more particularly lower than 70° C., in particular lower than 65° C.

As already previously mentioned, it is important that the temperature of the oil and cake resulting from the pressing of seeds or fruits of oilseed plants is low, so as not to alter the organoleptic properties of the oil and cake, and in particular for the cake so as not to denature the proteins it contains.

Also, according to the method of the invention, and with the addition of the aqueous solution, the temperature of the oil and cake is reduced so that at the end of pressing it is below 100° C. However, it is more advantageous if this temperature is below 85° C., in particular below 80° C., more advantageously below 75° C., in particular below 70° C., ideally below 65° C.

However, cake temperatures below 60° C. or even below 55° C. or 50° C. are all the more advantageous.

In other words, the temperature of the cake after pressing of oilseeds or fruits is lower than 100° C., 99° C., 98° C., 97° C., 96° C., 95° C., 94° C., 93° C., 92° C., 91° C., 90° C., 89° C., 88° C., 87° C., 86° C., 85° C., 84° C., 83° C., 82° C., 81° C. 80° C., 79° C., 78° C., 77° C., 76° C., 75° C., 74° C., 73° C., 72° C., 71° C. 70° C., 69° C., 68° C., 67° C., 66° C., 65° C., 64° C., 63° C., 62° C., 61° C., 60° C., 59° C., 58° C., 57° C., 56° C., 55° C., 54° C., 53° C., 52° C., 51° C., or below 50° C.

It should be noted that in the context of the invention, the press outlet temperature corresponds to the maximum temperature tolerated in the press during the pressing of the seeds or fruits. This temperature will advantageously be lower than 80° C., and in particular lower than 75° C.

The temperature can be measured by any means known to the person skilled in the art, and in particular by means of contact thermometers (electronic or mercury), or laser thermometers, or even by means of thermal cameras.

Advantageously, the above-mentioned method is such that the press used in the first step is a screw press, in particular a bar press, a screw tube press, or an extruder press. Examples of presses that can be used to implement the method of the invention are described below.

Even more advantageously, the invention relates to a method for extracting oil from whole rapeseed, i.e., unhulled and unflaked and optionally cleaned rapeseed, the method comprising:
one or more steps of cold pressing of rapeseed by means of one or more presses, said rapeseed being conveyed to the press by a conveyor,
a step of separation of the oily fraction and the solid fraction or cake,

said method being characterized in that at least a part of the seeds or fruits is moistened with an aqueous solution before pressing said rapeseed in order to decrease the temperature of the oil and the cakes resulting from the pressing.

Even more advantageously, the invention relates to a method for extracting oil from the aforementioned whole rapeseed, wherein at least a part of the seeds or fruits is moistened by spraying with an aqueous solution, in particular water, in particular tap water, prior to the pressing of said rapeseed.

The moistening of the rapeseed before pressing, at the press inlet, is such that the overall moisture content of the seeds must be greater than 7.5% by mass relative to the mass of the seeds. More particularly, the moisture content of the seeds is in the range of 8, 9, 10, 11, 12, 13, 14 or 15% moisture.

Even more advantageously, the invention relates to a method for extracting oil from the aforementioned whole rapeseed, wherein the pressing, i.e. the step of separation of the oily fraction from the solid fraction, is carried out at a temperature below 74° C., preferably below 72° C.

Even more advantageously, the invention relates to a method for extracting oil from the aforementioned whole rapeseed, wherein the pressing temperature is controlled by measuring the exit temperature of the cake.

The invention further relates to a de-oiled cake of seeds or fruits of oilseed protein plants, in particular a de-oiled cake of rapeseed, obtainable by the method as defined above, said cake comprising at most 17%, preferably at most 13%, of oil, the percentages being expressed by mass in relation to the total dry mass of the cake. This means that the percentage of oil should advantageously be between 8% and 13% by mass in relation to the total dry mass of the cake.

The de-oiled cake thus obtained is characterized in that its quantity of oil is limited, and its organoleptic and nutritional qualities are improved insofar as, due to the method used to obtain it, the temperature has remained controlled, thus limiting in particular modifications of the proteins (coagulation or denaturation).

The press cake as defined above contains from 10 to 12% moisture. Also in relation to the total mass of the cake, including the water contained therein, the cake can be characterized as containing from 6 to 15% by mass of oil, in particular from 8 to 12% by mass of oil, and preferably from 10 to 12% by mass of oil.

In the invention, the term “press cake” refers to the moment when the cake reaches the end of the worm screw and is expelled from the press.

Advantageously, the cake at the pressing outlet as defined above is at a temperature below 100° C. However, it is more advantageous that this temperature is below 85° C., in particular below 80° C., more advantageously below 75° C., in particular below 70° C., ideally below 65° C.

Cake temperatures below 60° C. or even below 55° C. or 50° C. are even more advantageous.

The amount of residual oil in the cake can be measured according to the method described in the international standard ISO 734, in its February 2016 version, which specifies a method for determining the hexane (or petroleum ether) extract, known as the “oil content” of cake (excluding compound products) from the extraction of oil from oilseeds by pressure or solvent.

The invention further relates to a device for extracting oil from fruits or seeds of oilseed plants, in particular from oilseed protein plants, by a mechanical cold pressing technique, the device being characterized in that it comprises:
a press equipped with an inlet and an outlet, the press comprising a worm screw, and a perforated casing forming a cage around the worm screw,

the worm screw and the casing being arranged so as to define at least one throttling zone, the throttling zone corresponding to a decrease in the distance between the worm screw shaft and the casing wall, and
a means of bringing an aqueous solution into contact with the fruits or seeds of oilseed protein plants to be pressed, said means being positioned upstream of the press inlet.

The device according to the invention may be formed of a commercially available press for pressing the seeds or fruits of oilseed plants. Also, and without being limiting, the presses covered by the present invention may be the following:
The presses marketed by the company REINARTZ, and in particular under the references AP08, AP10, AP12, AP14/22, AP14/30, AP15 or AP08,
the presses marketed by the company FRENCH, in particular the Achiever range,
the presses marketed by the company ROSEDOWNS, in particular those with serial numbers sterling 100, sterling 200, sterling 400, sterling 600, sterling 800, sterling 900,
the presses marketed by the company OLEXA, in particular those of reference MBU 260-280, MBU 330, MBU 530 or MBU 730
the presses marketed by the company CROWN IRON (formerly SKET) under the references KP15 and KP21, and
the presses marketed by the company FARMET, in particular those under the references FS 4015, FS 1010, FS 1020, FS 350 or FL 200.

The various embodiments of the device mentioned above are detailed below in the section entitled “Description of Advantageous Embodiments of the Device.”

In the invention, the casing of the press is said to be “perforated,” which means that it is open-worked, or has gaps through which oil can flow during the trituration or pressing of the seeds or fruits of oilseed plants. The cage is advantageously designed from bars juxtaposed to each other and separated from each other by means of spacers.

Advantageously, the invention relates to the aforementioned device, further comprising means for introducing or guiding to the press inlet the fruits or seeds of oilseed protein plants to be pressed, said introducing or guide means being positioned between said contacting means and the press inlet, said guide means allowing the introduction of the seeds or fruits at the inlet with a fixed flow rate.

Advantageously, the aforementioned device is such that said guide means is positioned upstream or at the inlet of the press, said guide means allowing the introduction of seeds or fruits at the inlet with a fixed flow rate.

The function of the guide means is to guide the entry of seeds or fruits of oilseed plants in the press in order to optimize the filling of the latter. This guide means is in particular a vertical or horizontal means which can be a conveyor belt, a funnel or any gravity guide means, or even is provided with a worm screw making it possible to direct the flow of seeds or fruits towards the press inlet.

This guide means is juxtaposed to the press at the press inlet, so that the guide means cooperates with the press to optimize the entry of seeds or fruit into the press.

Advantageously, the invention relates to the above-mentioned device, wherein the contacting means is a nozzle for spraying the aqueous solution, a pipe for adding the aqueous solution drop by drop, or a dipping tank.

Advantageously, the device is such that a temperature measuring means is positioned at the outlet of the press.

It is also advantageous that the device is provided with a means for controlling the aqueous solution contacting means, said control means controlling the flow rate of said aqueous solution. This control means can be, for example, a valve, possibly coupled to a pressure reducer associated in particular with a privileged control means, a regulation valve associated with a flow meter.

Even more advantageously, said temperature measuring means exerts a mechanical control on the aqueous solution contacting means, so that the aqueous solution is poured onto the fruits or seeds of oilseed protein plants to be pressed when the measured temperature is higher than 80° C., in particular higher than 70° C.

The temperature measuring means may also, depending on the configuration of the device, exert mechanical control over the aqueous solution contacting means so that the seeds or fruit are immersed in the aqueous solution.

The aqueous solution contacting means is advantageously a nozzle of which the closure and flow rate is controlled by a regulator, this regulator being itself controlled as a function of the outlet temperature as mentioned above. It may also be advantageous that a means for measuring the moisture of the fruits or the seeds of oilseed protein plants is positioned between the means for bringing the aqueous solution into contact with the fruits or the seeds of oilseed protein plants to be pressed and the inlet of the press.

Advantageously, the invention relates to a device as defined above, comprising at least one means for cooling the casing of the press.

The press cage can be provided with one or more means to cool the walls or the casing of the press cage. These means can be arranged outside the cage to cool the outside of the cage, which by convection will make it possible to decrease the temperature at the internal part of the casing where the seeds or the fruits are crushed and thus heat up by friction.

These cooling means can be of different nature, such as a circulation of cooled water through coils for example, a projection of cooled oil on the external walls of the cage, or a means making it possible to place a cooling element, for example dry ice, in contact with the external part of the cage.

It is also possible to cool the inner walls of the cage or worm screw by introducing dry ice into the press by means of a suitable device.

In accordance with French presses, screw presses have cage inserts, or sleeves, for steam heating or water cooling of the cages. They consist of holes drilled throughout the material to allow steam or cooling water to circulate to control the cage temperature. Heat transfer is achieved by thermal conduction between the thermo-regulated sleeves and the screening bars and by convection through oil leakage.

These sleeves are installed inside the press, between the main structure of the cage and the discharge elements: the screening bars, the spacers, the breaker bars and the center bars are assembled there. This is the main difference from the systems offered by other manufacturers.

Cage temperature control is quite rare in the industry and is indeed most often achieved by circulating the fluid directly through the cage structure, an option that is also covered by the present invention.

Advantageously, the invention relates to the aforementioned device, further comprising at least one means for cooling the screw.

In addition to the cooling of the press cage, it is also possible to provide the screw with means allowing its cooling. These means can be very varied like a system allowing a circulation of water, in particular cooled in the screw itself. It is also possible to introduce into the press dry ice, which, during its contact with the screw, will make it possible to reduce the temperature.

Of course, it is possible to advantageously combine the cooling means of the cage and the screw in order to promote the cooling of all the elements of the press simultaneously, and thus to control the rise in temperature related to the friction and the increase in pressure during the pressing.

Advantageously, the invention relates to the above-mentioned device, wherein the contacting means is a nozzle for spraying the aqueous solution, a pipe for adding the aqueous solution drop by drop, and wherein

said contacting means is arranged to bring the aqueous solution into contact with the seeds or fruits at a determined flow rate, the ratio between said determined flow rate and the fixed flow rate (kg per hour) varying from 0.2 to 10%, in particular from 0.2 to 5%, preferably from 0.5 to 2%, in particular about 1%.

Advantageously, the invention relates to the aforementioned device, wherein the contacting means is a soaking tank, said soaking tank being arranged for said seeds or fruits to be moistened by soaking in said aqueous solution for 0 to 30 minutes, so that said moistened seeds or fruits have a moisture content of 4% to 15%.

### BRIEF DESCRIPTION OF THE DRAWINGS

FIG. 1 illustrates a graph showing the evolution of the temperature in ° C. of the surface of the cake as a function of the speed of rotation of the feed screw (in rpm) with (B.) or without (A.) addition of water at a flow rate of 8 L·h⁻¹.

FIG. 2 is a graph showing the impact on the temperature (in ° C. Y axis) along the press (C1a: press inlet to C4c: press exit—effective pressing length of about 3 m) with unmoistened (A) or moistened (B) seeds. The speed is 8 rpm.

FIG. 3 is a graph showing the percentage of residual oil for the cakes, without addition of water (A) or with addition of water (B) as a function of the speed of the screw in rpm.

FIG. 4 is a graph showing the variation of seed flow rate without addition of water (A; circles) or with addition of water (B; squares) or of cake flow rate with addition of water (A′; circles) or with addition of water (B′; squares), as a function of the speed of the screw in rpm.

FIG. 5 is a graph showing the variation of specific intensity of the press without addition of water (A; circles) or with addition of water (B; squares) as a function of the screw speed in rpm.

FIG. 6 is a schematic representation of a press according to the invention.

FIG. 7 is a schematic representation of a press according to [FIG. 6] with a guide means.

FIG. 8 is a schematic representation of a press with a specific contacting means.

FIG. 9 is a schematic representation of a press according to which the contacting means is a basin.

FIG. 10 is an alternative schematic representation of a press according to [FIG. 9].

FIG. 11 is a schematic representation of a device according to the invention combining several presses and several contacting means.

FIG. 12 is a graph showing the impact of press cooling and water addition on the temperature of the cake at the press outlet. A: cake temperature in ° C., without press cooling or water addition; B: cake temperature in ° C., with press cooling but without water addition; and C: cake temperature in ° C., with press cooling and water addition.

FIG. 13 is a graph showing the impact of press cooling and water addition on the oil content of the cake at the press outlet. A: residual oil content in %, without press cooling and water addition; B: residual oil content in %, with press cooling but without water addition; and C: residual oil content in %, with press cooling and water addition.

FIG. 14 is a graph showing the impact of press cooling and water addition on the flow of seeds and cakes. A1: flow of seeds in kg·h⁻¹ without press cooling or water addition; A2: flow of cake in kg·h⁻¹ without press cooling or water addition; B1: flow of seeds in kg·h⁻¹ with press cooling but without water addition; B2: flow of cake in kg·h⁻¹ with press cooling but without water addition; and B1: flow of seeds in kg·h⁻¹ with press cooling and water addition and C2: flow of cake in kg·h⁻¹ with press cooling and water addition.

### DESCRIPTION OF ADVANTAGEOUS EMBODIMENTS OF THE DEVICE

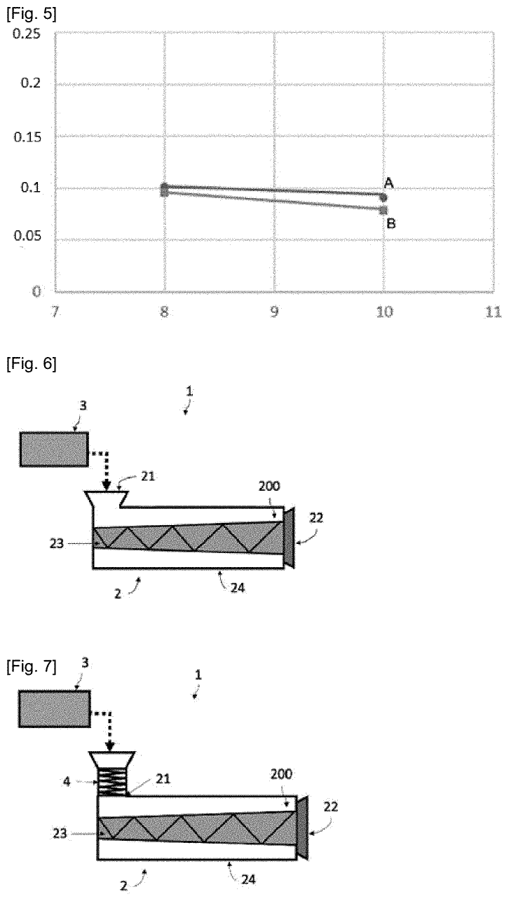

In the various FIGS. 6 to 11, the dotted arrows represent the direction of progression of the seeds or fruits, or cakes, through the device according to the invention.

Reference is now made to [FIG. 6] which shows a device 1 for extracting oil from fruits or seeds of oilseed protein plants by a mechanical cold pressing technique. This device consists of a press 2 and a means 3 for contacting the seeds or fruits with an aqueous solution.

The press 2 is formed of a cage 24 covering a worm screw 23, the screw being generally conical in shape with a circular base. The geometry of the screw is such that the space between the lateral edges of the screw and the interior of the cage is more restricted at certain points, defining a throttling zone 200, or several zones depending on the configuration of the screw, at which zone the seeds or fruits introduced into the press are most pressed against the cage 24.

The press is provided with an inlet 21 through which the seeds or fruits to be pressed are introduced, and where they will be brought into contact with the screw 23. The rotation of the screw 23 makes the seeds or fruits to be pressed progress through the press 2, as far as the outlet 22. As the seeds or fruits progress through the press 2, the oil obtained by the pressing of the seeds or fruits will be eliminated through bars or notches (not shown) provided on the side walls and on the bottom of the cage 24. The residue of pressing, or cake, will be directed and recovered at the outlet 22.

The device 1 is configured so that the contacting means 3 is positioned upstream of the inlet 21 of the press 2. Therefore, the seeds or fruits that will be introduced into the press 2 through the inlet 21 will have been brought into contact with the aqueous solution.

With reference to [FIG. 7], a device 1 similar to that of [FIG. 6] is shown, wherein at the inlet 21 of the press 2 there is arranged a guide means 4, serving to optimize the introduction of seeds or fruits into the press 2. This guide means 4 is advantageously a guide means with a screw for controlling the flow of seeds or fruits introduced into the press 2.

The contacting means 3, in this embodiment, is also upstream of the inlet 21 of the press 2, and upstream of the guide means 4. Thus, the seeds or fruits moistened by the contacting means 3 are introduced into the guide means 4, and are introduced into the press 2 through the inlet 21 for pressing.

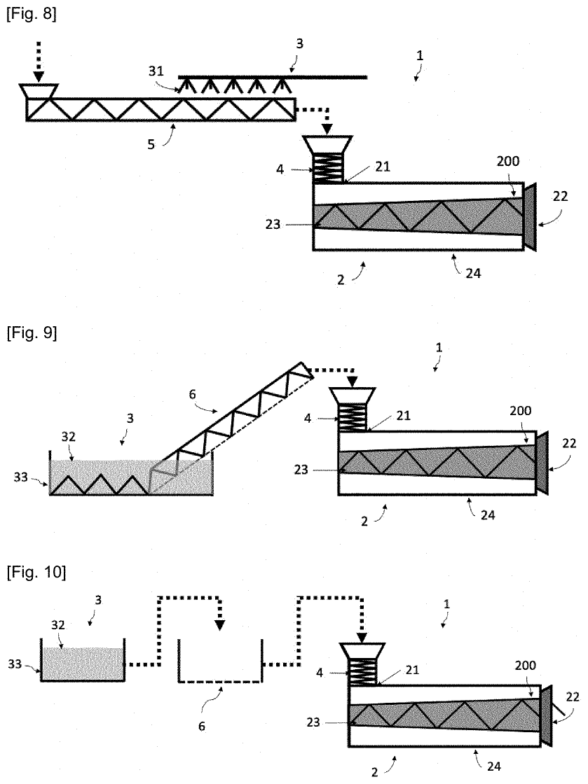

Referring to [FIG. 8], a device 1 according to the invention is now described in which the contacting means 3 is detailed. The contacting means of this embodiment is advantageously provided with a device, or conveyor 5, for conveying the seeds or fruits to be pressed to or towards the contacting means 3. The contacting means 3 is in turn provided with one or more distribution means 31 for releasing the aqueous solution so that it comes into contact with the seeds or fruits conveyed by the conveyor 5. These distribution means 31 can take the form of pipes, nozzles, spray nozzles, or any means allowing the controlled release of the aqueous solution.

In this embodiment, the seeds or fruits having been moistened by the aqueous solution through the contacting means 3 will then be introduced into the press 2 through the inlet 21, which may or may not be provided with a guide means 4.

In [FIG. 9], another embodiment of a contacting means 3 is shown. The contacting means 3 is a basin 33 filled with aqueous solution 32 in which the seeds or fruits to be pressed are immersed or bathed. The basin 33 can be provided with a screw or a means of conveying the seeds or fruits thus immersed. A draining means 6 positioned between the basin 33 and the press 2 is also provided, this draining means 6 making it possible to eliminate the excess of aqueous solution having adhered to the fruits or seeds during the soaking in the basin 33.

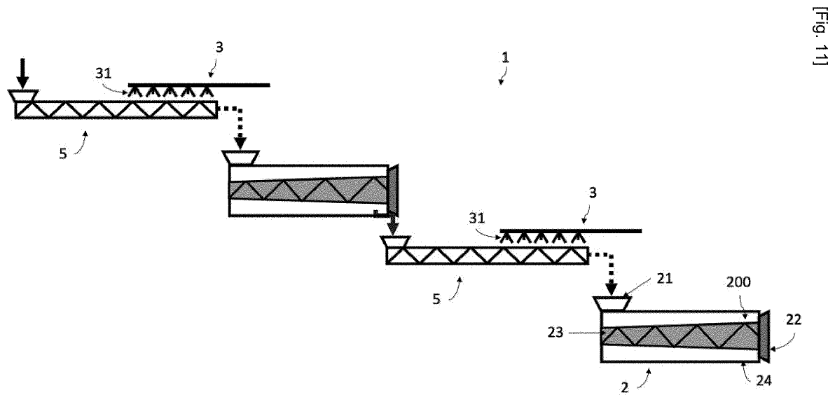

In this embodiment, the seeds or fruits having been moistened by the aqueous solution 33 through the contacting means 3 will then be introduced into the press 2 through the inlet 21, which may or may not be provided with a guide means 4.

[FIG. 10] shows an alternative arrangement of the device 1 shown in [FIG. 9]. In this embodiment, the draining means and the basin 33 containing the aqueous solution 32 are physically separated. The seeds or fruits having remained in the basin 33 to be brought into contact with the aqueous solution 32 will be transferred into or onto the draining means by any means easily usable by the person skilled in the art (elevator, basket, or simply by tipping the contents of the basin 33 into or onto the draining means 6).

In this embodiment, the seeds or fruits having been moistened by the aqueous solution 33 through the contacting means 3 will then be introduced into the press 2 through the inlet 21, which may or may not be provided with a guide means 4.

In advantageous embodiments, the device 1 may comprise more than one press 1 and more than one contacting means 3. This is, for example, illustrated in [FIG. 11]. The device 1 is provided with a first contacting means 3, followed by a press 2. At the exit of the first press, the cake is then placed back on a conveyor 5, advancing it to a second contacting means 3. After this second moistening, the moistened cake is introduced into a second press 2, for a second pressing. This is a duplication of the arrangement shown in [FIG. 8].

It is of course understood that duplications of the arrangements shown in FIGS. 9 and 10 are also covered by the present invention.

Also envisaged within the scope of the present invention are devices 1 combining the arrangements shown in FIGS. 8, 9 and 10. For example, covered by the present invention is a device comprising a pair of contacting means 3 and press 2 as shown in [FIG. 8], arranged so that the cake leaving the press is taken over by a second pair of contacting means 3 and press 2 as shown in [FIG. 9] or 10. The reverse is also possible.

In other words, the arrangements in FIGS. 8, 9 and 10 can be combined with each other.

### EXAMPLES

### Example 1

The objective of the tests carried out was to reduce the heating of cakes obtained during the pressing of oilseed plant seeds in a screw press, used for oil extraction.

The inventors conducted tests by spraying tap water on a flow of seeds before introducing it into a screw press.

Tests were carried out in a trituration unit working in cold pressing with a Reinartz AP15 press. This is an industrial press model, with a maximum capacity of 1 T/h, equipped with a frequency converter making it possible to adjust its rotation speed from 5 to 10 rpm.

The feeding of the press is gravitational and ensured by a horizontal screw conveyor, also on a frequency variator making it possible to adjust the flow of seeds introduced in the press.

In contrast to the standard Reinartz model, this press was equipped with a water cooling system in the shaft and in the last two cage sections (sections C3 and C4), as well as a screw arrangement optimized for spring rapeseed.

A water spray system was installed above the penultimate section of the feed screw. In this test, the spray system is a flexible garden hose, connected to the running water system, and a faucet. The faucet was opened very slightly, so that only a very small flow of water was added to the seeds. In this way, the flow was a small trickle of water that resulted in a very heterogeneous distribution, with some seeds heavily moistened and others remaining dry.

Water spray pressing tests were performed on spring rapeseed from Latvia, cleaned but not pretreated (no flattening or cooking).

The operating performances obtained with and without the addition of water to the feed were compared, for identical operating conditions. For this purpose, in both cases, the press was operated with a full screw (with cooling water circulation at 5° C. in the shaft and the last two cage sections (C3 and C4)), at two different screw rotation speeds (8 and 10 rpm).

1—Control 1: diameter of die holes 7 mm/cooling of cage and shaft by water at 5° C./No addition of water.

Press shaft speed 80% of nominal (8 rpm)/screw feeding speed 27% (corresponds to 449 kg/of cake or 830 kg/h of seeds approximately)

1—Control 2: diameter of die holes 7 mm/cooling of cage and shaft by water at 5° C./No addition of water.

Press shaft speed 100% of nominal (10 rpm)/screw feeding speed 30% (corresponds to 520 kg/of cake or 920 kg/h of seeds approximately)

2—Test no 1: diameter of die holes 7 mm/cooling of cage and shaft by water at 5° C./addition of water in screw feed 8 L/h,

Press shaft speed 80% of nominal (8 rpm)/screw feeding speed 27% (corresponds to 438 kg/of cake or 830 kg/h of seeds approximately)

3—Test no 2: diameter of die holes 7 mm/cooling of cage and shaft by water at 5° C./addition of water in screw feed 8 L/h

Press shaft speed 100% of nominal (10 rpm)/screw feeding speed 30% (corresponds to 520 kg/of cake or 920 kg/h of seeds approximately)

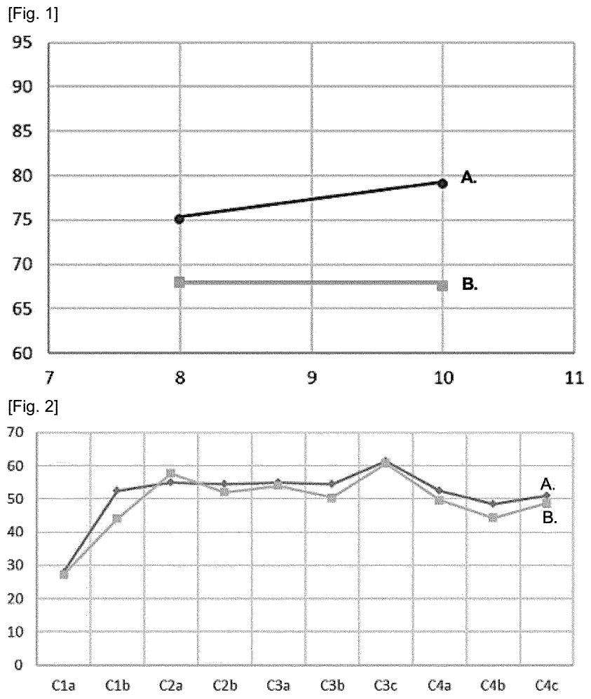

The temperature results without watering (A) and with watering at 8 L/h (B) are shown in [FIG. 1].

All of these results show that the addition of water at the screw feed significantly reduces the temperature of the cakes.

There is a significant decrease in the final temperature of the cake after pressing, with a drop of 7° C. at 8 rpm and 10° C. at 10 rpm.

Next, the inventors established the temperature profile along the press cage without (A) or with (B) addition of water to the seeds prior to entering the press.

The results are shown in [FIG. 2].

These results show that with and without the addition of water, the temperature variation follows a very similar evolution, but actually shows a slight decrease in the case of the addition of water, for almost all the measuring points. This confirms the reduction of friction, desired by the inventors.

Next, the inventors tested whether the addition of water to the seeds prior to pressing had an effect on oil production, and thus cake de-oiling. The inventors compared the oil content of cakes produced by pressing without (A) or with (B) the addition of water, at a speed of 8 or 10 rpm.

The oil content is measured according to the method defined in the international standard ISO 734 in its February 2016 version.

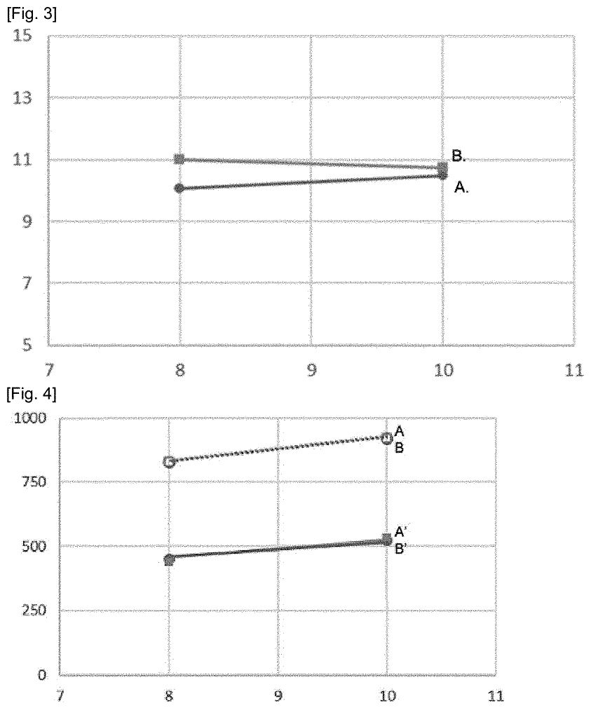

The results are shown in [FIG. 3].

While the residual oil content obtained without the addition of water is generally around 10% by mass in relation to the dry mass of the cake, it would seem that in the case where water is added, this addition induces a slight decrease in the de-oiling performance and thus an increase in the residual oil content around 11%.

Ultimately, an important characteristic to determine was whether water addition impacted seed flow rates (A without water addition and B with water addition) and cake flow rates (A′ without water addition and B′ with water addition) during pressing, as well as specific press intensity (A without water addition and B with water addition).

The results are shown in [FIG. 4] for the flow rates and in [FIG. 5] for the intensity.

They reveal that the addition of water has no influence on the flow rates of treated seeds and cake produced, but induces a slight decrease in the specific intensity of the press, related to the decrease in de-oiling mentioned above.

A drop in specific intensity was even observed during the tests, during the adjustment of the water flow rate, showing that an excessive flow rate can reduce the stresses in the press, i.e. the friction but also the de-oiling performance. Therefore, the inventors set the water flow rate to be added as mentioned above.

### Example 2

Using the device described in the previous example, the inventors then wanted to compare the efficiency of cooling the press by water circulation in its shaft and cage and of cooling induced by moistening of the pressed seeds.

Pressing tests were carried out on spring rapeseed from Latvia, cleaned but not pre-treated (no flattening or cooking).

The operating performances obtained with and without cooling of the press and with and without addition of water to the feed were compared, for identical operating conditions. For this purpose, for the 3 modalities, the press was operated with a full screw, at a rotation speed of 8 rpm.

1—Control 1 (A): diameter of die holes 7 mm/No cooling of shaft and cage/No addition of water.

Press shaft speed 80% of nominal (8 rpm)/screw feeding speed 27% (corresponds to 438 kg/of cake or 830 kg/h of seeds approximately)

1—Control 2 (B): diameter of die holes 7 mm/cooling of cage and shaft by water at 5° C./No addition of water.

Press shaft speed 80% of nominal (8 rpm)/screw feeding speed 27% (corresponds to 449 kg/of cake or 830 kg/h of seeds approximately)

2—Test no 1 (C): diameter of die holes 7 mm/cooling of cage and shaft by water at 5° C./addition of water in screw feeding 8 L/h.

Press shaft speed 80% of nominal (8 rpm)/screw feeding speed 27% (corresponds to 445 kg/of cake or 830 kg/h of seeds approximately)

The results for temperature without cooling and without watering (A) and with cooling and without watering (B) and with cooling and with watering at 8 L/h (C) are shown in [FIG. 12].

These results show that the addition of water at the screw feed significantly improves the temperature drop of the cakes linked to the cooling of the press by water circulation in its shaft and cage.

A decrease is observed in the final temperature of the cake, after pressing, of 3° C. (temperature difference between A and B; [FIG. 12]) by the effect of the cooling of the press and of 7° C. (temperature difference between B and C; [FIG. 12]) by the effect of the addition of water.

Next, the inventors tested whether the cooling of the press and the addition of water to the seeds before pressing had an effect on oil production, and thus on the de-oiling of the cakes. The inventors therefore compared the oil content of cakes from pressing without cooling and without watering (A) and with cooling and without watering (B) and with cooling and with watering at 8 L/h (C).

The oil content is measured according to the method defined in the international standard ISO 734 in its February 2016 version.

The results are shown in [FIG. 13].

It can be seen that, even if the addition of water affects the de-oiling of the cakes, the oil content after pressing remains below 12%, which is a perfectly acceptable amount.

Ultimately, an important characteristic to determine was whether press cooling and water addition impacted seed and cake flow rates during pressing, as well as the specific intensity of the press.

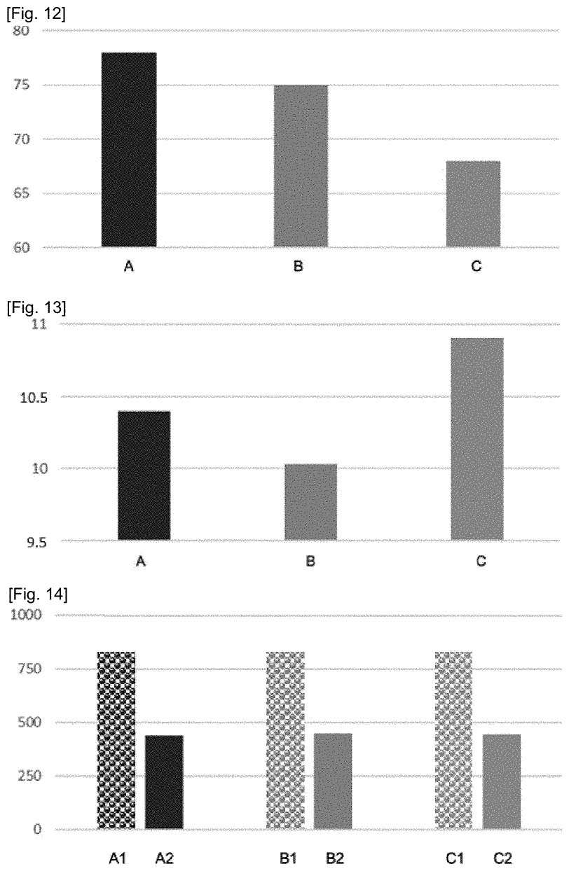

The results are shown in [FIG. 14] for the flow rates.

They reveal that neither the cooling of the press nor the addition of water has any influence on the flow rates of treated seeds and cake produced.

1. A method for extracting oil from seeds or fruits of oilseed plants, comprising:
one or more steps of cold pressing of the seeds or fruits by means of one or more presses, said seeds or said fruits being conveyed to the one or more presses by a conveyor, and
a step of separating the oily fraction and the solid fraction or cake,
wherein at least a part of the seeds or fruits is moistened with an aqueous solution prior to the pressing of said seeds or said fruits in order to decrease the temperature of the oil and cakes resulting from the pressing.

2. The method according to claim 1, wherein the aqueous solution is added at a determined flow rate, such that the ratio between said determined flow rate and the flow rate of at least partially moistened seeds or fruits introduced into the press varies from 0.2 to 10%.

3. The method according to claim 1, wherein said seeds or said fruits are moistened by soaking in said aqueous solution for 0 to 30 minutes, such that said moistened seeds or fruits have a moisture content of 4 to 15%.

4. The method according to claim 1, wherein the temperature within the one or more presses is below 100° C.

5. A de-oiled cake of seeds or fruits of oilseed protein plants, obtainable by the method according to claim 1, wherein said cake comprising at most 17% of oil, the percentages being expressed in mass in relation to the total dry mass of the cake.

6. A device for extracting oil from fruits or seeds of oilseed protein plants by a mechanical cold pressing technique, comprising:
a press equipped with an inlet and an outlet, the press comprising a worm screw, and a perforated casing forming a cage around the worm screw, the worm screw and the casing being arranged so as to define at least one throttling zone, the throttling zone corresponding to a decrease in the distance between the shaft of the worm screw and the wall of the casing, and
a contacting means for bringing an aqueous solution into contact with the fruits or seeds of oilseed protein plants to be pressed, wherein contacting said means being positioned upstream of the inlet of the press.

7. The device according to claim 6, further comprising a guide means, at the inlet of the press, said guide means being positioned between said contacting means and the inlet of the press, said guide means allowing the introduction of the seeds or fruits at the inlet with a fixed flow rate.

8. The device according to claim 6, wherein the contacting means is a nozzle for spraying the aqueous solution, a pipe for adding the aqueous solution drop by drop, or a dipping tank.

9. A device according to claim 6, comprising at least one means for cooling the casing of the press.

10. The device according to claim 6, further comprising at least one means for cooling the screw.

11. The method according to claim 1, wherein the oilseed plants are oilseed protein plants.

12. The method according to claim 1, wherein the ratio between said determined flow rate and the flow rate of at least partially moistened seeds or fruits introduced into the press varies from 0.2 to 5%.

13. The method according to claim 1, wherein the ratio between said determined flow rate and the flow rate of at least partially moistened seeds or fruits introduced into the press varies from 0.5 to 2%.

14. The method according to claim 1, wherein the temperature within the one or more presses is below 85° C.

15. The method according to claim 1, wherein the temperature within the one or more presses is below 75° C.

16. The method according to claim 1, wherein the temperature within the one or more presses is below 65° C.

17. The method according to claim 5, wherein said cake comprises at most 13% of oil.
